(19) United States
(12) Patent Application Publication
(10) Pub. No.: US 2022/0246986 A1
(43) Pub. Date: Aug. 4, 2022

(54) MAGNESIUM SECONDARY BATTERY AND NON-AQUEOUS ELECTROLYTE SOLUTION FOR MAGNESIUM SECONDARY BATTERY

(71) Applicant: Panasonic Intellectual Property Management Co., Ltd., Osaka (JP)

(72) Inventor: TOMOFUMI HAMAMURA, Kanagawa (JP)

(21) Appl. No.: 17/659,774

(22) Filed: Apr. 19, 2022

Related U.S. Application Data
(63) Continuation of application No. PCT/JP2020/016237, filed on Apr. 13, 2020.

(30) Foreign Application Priority Data
Nov. 22, 2019 (JP) 2019-211206

(51) Int. Cl. H01M 10/0567; H01M 10/054; H01M 10/0569; H01M 10/0568

(52) U.S. Cl. CPC H01M 10/0567; H01M 10/054; H01M 2300/0028; H01M 10/0568; H01M 10/0569

(57) ABSTRACT

A non-aqueous electrolyte solution for a magnesium secondary battery includes a non-aqueous solvent, a magnesium salt, and an organoaluminum ate complex salt represented by formula (1) below. In formula (1), R₁, R₂, R₃, and R₄ are each independently (i) an alkyl group or (ii) an alkyl group with a functional group.

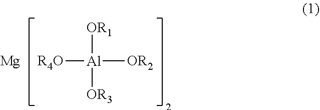

### BACKGROUND

### 1. Technical Field

The present disclosure relates to a magnesium secondary battery and a non-aqueous electrolyte solution for a magnesium secondary battery.

### 2. Description of the Related Art

In recent years, the development of magnesium secondary batteries has been expected.

Japanese Unexamined Patent Application Publication No. 2017-22024 describes an electrolyte solution that is to be used in a magnesium secondary battery. The electrolyte solution includes a magnesium salt and a cyclic acid anhydride.

J. Mater. Chem. A, 2019, 7, 2677-2685 describes an electrolyte that is to be used in a magnesium secondary battery. The electrolyte is an alkylated aluminum complex.

### SUMMARY

In one general aspect, the techniques disclosed here feature a non-aqueous electrolyte solution for a magnesium secondary battery. The non-aqueous electrolyte solution includes a non-aqueous solvent, a magnesium salt, and an organoaluminum ate complex salt represented by formula (1) below.

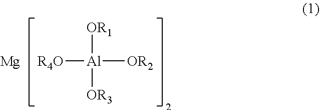

In formula (1), R₁, R₂, R₃, and R₄ are each independently (i) an alkyl group or (ii) an alkyl group with a functional group.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of an exemplary configuration of a magnesium secondary battery;

FIG. 2 is a graph showing a cyclic voltammogram of Samples 1 and 2; and

FIG. 3 is a graph showing a cyclic voltammogram of Samples 3 and 4.

### DETAILED DESCRIPTION

### Underlying Knowledge Forming Basis of the Present Disclosure

Magnesium secondary batteries are expected to serve as high-capacity secondary batteries. This is because the two-electron reaction due to magnesium can be utilized. However, a strong interaction between the divalent magnesium ions and the surrounding solvent makes it difficult for the solvent to be separated from the magnesium ions. That is, in a non-aqueous electrolyte solution for a magnesium secondary battery, the deposition and dissolution of magnesium metal do not readily occur. This is a problem unique to non-aqueous electrolyte solutions for a magnesium secondary battery. For example, existing magnesium secondary batteries use a non-aqueous electrolyte solution obtained by dissolving a magnesium salt in glyme, such as 1,2-dimethoxyethane. Unfortunately, magnesium secondary batteries that use such a non-aqueous electrolyte solution have low coulombic efficiency. Because of this problem, combinations of a non-aqueous solvent and a magnesium salt that can be used in magnesium secondary batteries are severely limited.

Based on the knowledge described above, the present inventors discovered a novel non-aqueous electrolyte solution, which is described below.

### Overview of Aspects of the Present Disclosure

According to a first aspect of the present disclosure, a non-aqueous electrolyte solution for a magnesium secondary battery includes

a non-aqueous solvent,

a magnesium salt, and

an organoaluminum ate complex salt represented by formula (1) below.

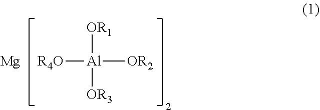

In formula (1), R₁, R₂, R₃, and R₄ are each independently (i) an alkyl group or (ii) an alkyl group with a functional group.

With regard to the first aspect, the organoaluminum ate complex salt enables uniform distribution of magnesium ions on a surface of electrodes. As a result, the deposition and dissolution of magnesium metal are promoted, and, consequently, the charge-discharge efficiency of a magnesium secondary battery is improved.

According to a second aspect of the present disclosure, for example, in the non-aqueous electrolyte solution for a magnesium secondary battery according to the first aspect, the non-aqueous solvent may include an ether. The magnesium salt can be sufficiently dissolved in an ether.

According to a third aspect of the present disclosure, for example, in the non-aqueous electrolyte solution for a magnesium secondary battery according to the second aspect, the non-aqueous solvent including an ether may include glyme.

According to a fourth aspect of the present disclosure, for example, in the non-aqueous electrolyte solution for a magnesium secondary battery according to the third aspect, the glyme may include at least one selected from the group consisting of 1,2-dimethoxyethane, diglyme, triglyme, and tetraglyme.

With regard to the third and fourth aspects, the magnesium salt can be sufficiently dissolved.

According to a fifth aspect of the present disclosure, for example, in the non-aqueous electrolyte solution for a magnesium secondary battery according to any one of the first to fourth aspects, in formula (1), R₁, R₂, R₃, and R₄ may be each independently represented by —CₓH_{y}F_{z}, where 1×4 may be satisfied, 0≤y<9 may be satisfied, and 1≤z≤9 may be satisfied. With regard to the fifth aspect of the present disclosure, a withstand voltage of the complex ion of the organoaluminum ate complex salt is increased. Accordingly, the electrochemical stability of the non-aqueous electrolyte solution is improved.

According to a sixth aspect of the present disclosure, for example, in the non-aqueous electrolyte solution for a magnesium secondary battery according to any one of the first to fifth aspects, the magnesium salt may include an anion, and the anion may be at least one selected from the group consisting of Cl⁻, BF₄⁻, [N(FSO₂)₂]⁻, [N(CF₃SO₂)₂]⁻, [N(C₂F₅SO₂)₂]⁻, [N(FSO₂)(CF₃SO₂)]⁻, [CₖBₘHₙ]⁻, and [BOR₅OR₆OR₇OR₈]⁻, where k and m may be each independently an integer greater than or equal to 1, k+m=n may be satisfied, n≤60 may be satisfied, and R₅, R₆, R₇, and R₈ may be each independently (i) an alkyl group or (ii) an alkyl group with a functional group.

According to a seventh aspect of the present disclosure, for example, in the non-aqueous electrolyte solution for a magnesium secondary battery according to any one of the first to fifth aspects, the magnesium salt may include an anion, and the anion may be [CₖBₘHₙXₚ]⁻, where k, m, and p may be each independently an integer greater than or equal to 1, k+m≤n+p may be satisfied, n+p≤60 may be satisfied, and X may be at least one selected from the group consisting of F, Cl, Br, and I.

With regard to the sixth and seventh aspects, these anions can form a salt with magnesium.

According to an eighth aspect of the present disclosure, a magnesium secondary battery includes

a positive electrode,

a negative electrode, and

the non-aqueous electrolyte solution for a magnesium secondary battery according to any one of the first to seventh aspects.

With regard to the eighth aspect, using the non-aqueous electrolyte solution for a magnesium secondary battery according to any one of the first to seventh aspects enables the deposition and dissolution of magnesium metal to be promoted. As a result, the charge-discharge efficiency of the magnesium secondary battery is improved.

Now, a non-aqueous electrolyte solution for a magnesium secondary battery according to an embodiment will be described in detail with reference to the drawings. In addition, a magnesium secondary battery that uses the non-aqueous electrolyte solution will be described in detail with reference to the drawings.

All of the following descriptions relate to a generic or specific example. In the descriptions, the mentioned numerical values, compositions, shapes, thicknesses, electrical properties, and structures of secondary batteries are merely examples and are not intended to limit the present disclosure. Constituent elements not described in the independent claim, which represents the most generic concept, are optional constituent elements.

### 1. Non-Aqueous Electrolyte Solution

According to an embodiment of the present disclosure, a non-aqueous electrolyte solution for a magnesium secondary battery includes a non-aqueous solvent, a magnesium salt, and an organoaluminum ate complex salt. The organoaluminum ate complex salt has a structure represented by formula (1) below. In formula (1) below, R₁, R₂, R₃, and R₄ are each independently (i) an alkyl group or (ii) an alkyl group with a functional group. The magnesium salt and the organoaluminum ate complex salt are dissolved in the non-aqueous solvent. The organoaluminum ate complex salt enables uniform distribution of magnesium ions on a surface of electrodes. As a result, the deposition and dissolution of magnesium metal are promoted, and, consequently, the charge-discharge efficiency of a magnesium secondary battery is improved.

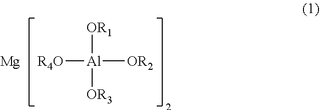

Organoaluminum ate complex salts enable uniform distribution of magnesium ions in the vicinities of electrodes. Accordingly, non-aqueous electrolyte solutions including an organoaluminum ate complex salt can promote the dissolution of magnesium metal. Consequently, the coulombic efficiency of magnesium metal can be improved in accordance with a desired condition. The “desired condition” may be, for example, at least one of (i) high magnesium ion conductivity, (ii) electrochemical stability, (iii) chemical stability, (iv) thermal stability, (v) safety, (vi) low environmental impact, and (vii) low cost. For example, the magnesium ion conductivity of a non-aqueous electrolyte solution can be increased by dissolving a magnesium salt in a non-aqueous solvent at a high concentration. For example, a non-aqueous electrolyte solution that is electrochemically stable can be obtained by selecting a non-aqueous solvent having high oxidation resistance. For example, a non-aqueous electrolyte solution with a high level of safety can be obtained by selecting a non-aqueous solvent having low toxicity.

In the present disclosure, the “organoaluminum ate complex salt” refers to a salt including a magnesium ion and a complex ion of an organoaluminum ate complex. In the complex ion of the organoaluminum ate complex, four oxygen atoms are bonded to an aluminum atom. Each of the oxygen atoms has a substituent bonded thereto.

The complex ion of an organoaluminum ate complex is larger than the complex ion of an organoboron ate complex. Accordingly, a center-to-center distance between the magnesium ion and the complex ion of an organoaluminum ate complex is greater than a center-to-center distance between the magnesium ion and the complex ion of an organoboron ate complex. Consequently, a bonding ability between the magnesium ion and the complex ion of an organoaluminum ate complex is weaker than a bonding ability between the magnesium ion and the complex ion of an organoboron ate complex. Thus, an organoaluminum ate complex salt can be electrolytically dissociated more easily than an organoboron ate complex salt.

The organoaluminum ate complex salt contains substituents R₁, R₂, R₃, and R₄. R₁, R₂, R₃, and R₄ may be substituents that are identical to or different from one another. R₁, R₂, R₃, and R₄ may each independently be an alkyl group. The alkyl group may be linear or branched. The number of carbon atoms in the alkyl group is not particularly limited. In instances where the number of carbon atoms in the alkyl group is appropriately adjusted, the organoaluminum ate complex salt can be easily dissolved in the non-aqueous solvent. The number of carbon atoms in the alkyl group may be greater than or equal to 1 and less than or equal to 4 so that a solubility in a polar solvent can be achieved. R₁, R₂, R₃, and R₄ may be alkyl groups that are identical to or different from one another.

R₁, R₂, R₃, and R₄ may each independently be an alkyl group with a functional group. The “alkyl group with a functional group” refers to an alkyl group in which at least one of the hydrogen atoms present in the alkyl group is replaced with a functional group. All of the hydrogen atoms present in the alkyl group may be replaced with a functional group. In instances where the alkyl group contains two or more functional groups, the two or more functional groups may be identical to or different from one another. Examples of the functional group include halogen groups, amino groups, hydroxyl groups, and carboxyl groups.

The alkyl group with a functional group may be a fluoroalkyl group. R₁, R₂, R₃, and R₄ may each independently be a fluoroalkyl group. The “fluoroalkyl group” refers to an alkyl group in which at least one of the hydrogen atoms present in the alkyl group is replaced with a fluorine atom. All of the hydrogen atoms present in the alkyl group may be replaced with a fluorine atom. In instances where a fluoroalkyl group is used, a withstand voltage of the complex ion of the organoaluminum ate complex is improved. Accordingly, the electrochemical stability of the non-aqueous electrolyte solution is improved. Furthermore, the greater the number of fluorine atoms present in the alkyl group, the further the electrochemical stability of the organoaluminum ate complex salt is improved by an inductive effect.

The fluoroalkyl group may be linear or branched. The number of carbon atoms in the fluoroalkyl group may be greater than or equal to 1 and less than or equal to 4 so that a solubility in a polar solvent can be achieved. The fluoroalkyl group may be represented, for example, by —CₓH_{y}F_{z}. 1≤x≤4 is satisfied. 0≤y<9 is satisfied. 1≤z≤9 is satisfied. The fluoroalkyl group may be a substituent in which at least one of the hydrogen atoms present in an alkyl group is replaced with a fluorine atom. Examples of the alkyl group include methyl groups, ethyl groups, n-propyl groups, isopropyl groups, n-butyl groups, isobutyl groups, sec-butyl groups, and tert-butyl groups.

The magnesium salt includes an anion. The anion is a monovalent anion, for example.

The magnesium salt includes at least one type of anion selected from the group consisting of Cl⁻, BF₄⁻, [N(FSO₂)₂]⁻, [N(CF₃SO₂)₂]⁻, [N(C₂F₅SO₂)₂]⁻, [N(FSO₂)(CF₃SO₂)]⁻, [CₖBₘHₙ]⁻, and [BOR₅OR₆OR₇OR₈]⁻. k and m are each independently an integer greater than or equal to 1. k+m=n is satisfied, and n≤60 is satisfied. These anions can form a salt with magnesium.

Magnesium salts including [BOR₅OR₆OR₇OR₈]⁻ are organoboron ate complex salts. The “organoboron ate complex salt” refers to a salt including a magnesium ion and a complex ion of an organoboron ate complex. In the complex ion of the organoboron ate complex, four oxygen atoms are bonded to a boron atom. Each of the oxygen atoms has a substituent bonded thereto. The organoboron ate complex salt contains substituents R₅, R₆, R₇, and R₈. R₅, R₆, R₇, and R₈ are each independently (i) an alkyl group or (ii) an alkyl group with a functional group. R₅, R₆, R₇, and R₈ may be substituents that are identical to or different from one another. Such organoboron ate complex salts enable uniform distribution of magnesium ions on a surface of electrodes. As a result, the deposition and dissolution of magnesium metal derived from the magnesium salt are promoted, which improves the electrochemical stability of the non-aqueous electrolyte solution.

R₅, R₆, R₇, and R₈ may each independently be an alkyl group. The alkyl group may be linear or branched. The number of carbon atoms in the alkyl group is not particularly limited. In instances where the number of carbon atoms in the alkyl group is appropriately adjusted, the organoboron ate complex salt can be easily dissolved in the non-aqueous solvent. The number of carbon atoms in the alkyl group may be greater than or equal to 1 and less than or equal to 4 so that a solubility in a polar solvent can be achieved. R₅, R₆, R₇, and R₈ may be alkyl groups that are identical to or different from one another.

R₅, R₆, R₇, and R₈ may each independently be an alkyl group with a functional group. The “alkyl group with a functional group” refers to an alkyl group in which at least one of the hydrogen atoms present in the alkyl group is replaced with a functional group. All of the hydrogen atoms present in the alkyl group may be replaced with a functional group. In instances where the alkyl group contains two or more functional groups, the two or more functional groups may be identical to or different from one another. Examples of the functional group include halogen groups, amino groups, hydroxyl groups, and carboxyl groups.

The alkyl group with a functional group may be a fluoroalkyl group. R₅, R₆, R₇, and R₈ may each independently be a fluoroalkyl group. All of the hydrogen atoms present in the alkyl group may be replaced with a fluorine atom. In instances where a fluoroalkyl group is used, a withstand voltage of the complex ion of the organoboron ate complex is improved. Accordingly, the electrochemical stability of the non-aqueous electrolyte solution is improved. Furthermore, the greater the number of fluorine atoms present in the alkyl group, the further the electrochemical stability of the organoboron ate complex salt is improved by an inductive effect.

The fluoroalkyl group may be linear or branched. The number of carbon atoms in the fluoroalkyl group may be greater than or equal to 1 and less than or equal to 4 so that a solubility in a polar solvent can be achieved. The fluoroalkyl group may be represented, for example, by —CₓH_{y}F_{z}. 1≤x≤4 is satisfied. 0≤y<9 is satisfied. 1≤z≤9 is satisfied. The fluoroalkyl group may be a substituent in which at least one of the hydrogen atoms present in an alkyl group is replaced with a fluorine atom. Examples of the alkyl group include methyl groups, ethyl groups, n-propyl groups, isopropyl groups, n-butyl groups, isobutyl groups, sec-butyl groups, and tert-butyl groups.

The magnesium salt may be a magnesium salt of an imide. Specifically, the magnesium salt of an imide may include at least one type of anion selected from the group consisting of [N(FSO₂)₂]⁻, [N(CF₃SO₂)₂]⁻, [N(C₂F₅SO₂)₂]⁻, and [N(FSO₂)(CF₃SO₂)]⁻. These anions can form a salt with magnesium.

The magnesium salt may include [CₖBₘHₙXₚ]⁻. k, m, and p are each independently an integer greater than or equal to 1. k+m≤n+p is satisfied, and n+p≤60 is satisfied. X is at least one selected from the group consisting of F, Cl, Br, and I. [CₖBₘHₙXₚ]⁻ that satisfies the above-mentioned conditions can form a salt with magnesium.

The non-aqueous solvent is not particularly limited provided that the magnesium salt can be dissolved in the non-aqueous solvent. The non-aqueous solvent may include an ether. The magnesium salt can be sufficiently dissolved in an ether. The non-aqueous solvent may include glyme so that a solubility can be achieved. Glyme can form a bidentate coordination with a magnesium ion. In the instance where glyme is used, the solubility of the magnesium salt of an imide in the non-aqueous solvent is improved. Examples of the glyme include 1,2-dimethoxyethane (DME), diglyme, triglyme, and tetraglyme. The non-aqueous solvent may include a fluorinated ether so that oxidation resistance can be achieved. The “fluorinated ether” refers to an ether in which at least one of the hydrogen atoms present in the ether is replaced with a fluorine atom.

The organoaluminum ate complex salt may form a coordinate bond with an ether present in the non-aqueous solvent or with a different ether. Specifically, the magnesium ions in the organoaluminum ate complex salt may form a coordinate bond with an ether. In the instance where a coordinate bond is formed between the organoaluminum ate complex salt and an ether, electrolytic dissociation of the magnesium ions is promoted when the organoaluminum ate complex salt is being dissolved into the non-aqueous solvent. The ether that may form a coordinate bond with the organoaluminum ate complex salt may include glyme. In the instance where glyme is used, it is possible to reduce the number of ethers that are to form a coordinate bond with the magnesium ions of the organoaluminum ate complex salt. As a result, a withstand voltage of the non-aqueous electrolyte solution is improved, and the solubility of the organoaluminum ate complex salt in the non-aqueous solvent is improved. When the organoaluminum ate complex salt is being dissolved into the non-aqueous solvent, the ether coordinated to the organoaluminum ate complex salt and the ether present in the non-aqueous solvent may be replaced by each other.

The ether that may be coordinated to the magnesium ions of the organoaluminum ate complex salt may include tetrahydrofuran (hereinafter referred to as “THF”). A bonding ability of THE with respect to magnesium ions is weaker than a bonding ability of glyme with respect to magnesium ions. Accordingly, after the organoaluminum ate complex salt is dissolved into the non-aqueous solvent, the THF coordinated to the magnesium ions can be readily replaced with the non-aqueous solvent. That is, the solubility of the organoaluminum ate complex salt in the non-aqueous solvent can be further improved.

In the non-aqueous electrolyte solution, a concentration of the magnesium salt is not particularly limited. In instances where any appropriate concentration of the magnesium salt is selected, the magnesium ion conductivity can be improved. The concentration of the magnesium salt in the non-aqueous electrolyte solution may be higher than the concentration of the organoaluminum ate complex salt in the non-aqueous electrolyte solution. In the instance where the concentration of the magnesium salt is higher than the concentration of the organoaluminum ate complex salt, thermal stability of the non-aqueous electrolyte solution is improved.

### 2. Magnesium Secondary Battery

### 2-1. Overall Configuration

The non-aqueous electrolyte solution according to the embodiment can be used in a magnesium secondary battery. The magnesium secondary battery includes a positive electrode, a negative electrode, and a non-aqueous electrolyte solution having magnesium ion conductivity. As the non-aqueous electrolyte solution, the non-aqueous electrolyte solution described in the “1. Non-Aqueous Electrolyte Solution” section can be appropriately used. In the instance where the non-aqueous electrolyte solution of the present disclosure is used, the deposition and dissolution of magnesium metal are promoted. As a result, the charge-discharge efficiency of the magnesium secondary battery is improved.

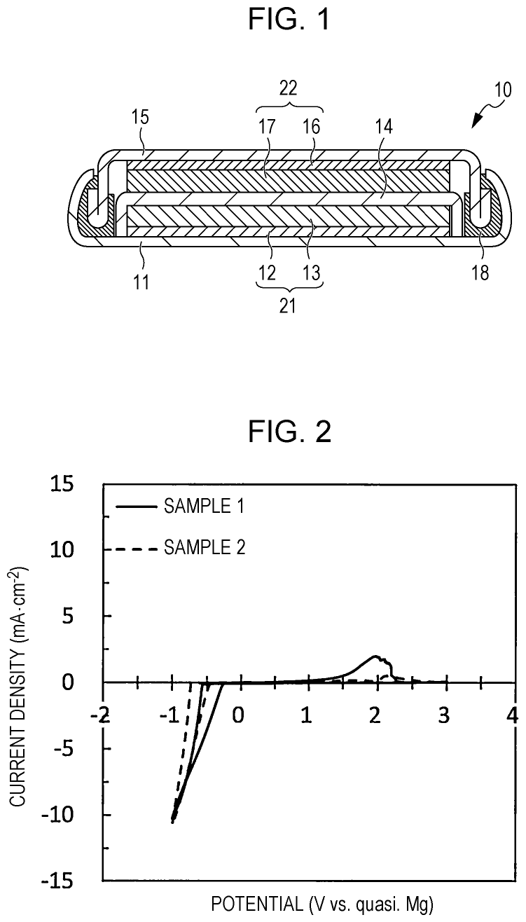

FIG. 1 is a schematic cross-sectional view of an exemplary configuration of a magnesium secondary battery 10.

The magnesium secondary battery 10 includes a positive electrode 21, a negative electrode 22, a separator 14, a case 11, a seal plate 15, and a gasket 18. The separator 14 is disposed between the positive electrode 21 and the negative electrode 22. The positive electrode 21, the negative electrode 22, and the separator 14 are impregnated with a non-aqueous electrolyte solution and are contained in the case 11. The case 11 is closed with the gasket 18 and the seal plate 15.

A structure of the magnesium secondary battery 10 may be a cylindrical structure, a prismatic structure, a button-type structure, a coin-type structure, or a flat structure.

### 2-2. Positive Electrode

The positive electrode 21 includes a positive electrode current collector 12 and a positive electrode active material layer 13, which is disposed on the positive electrode current collector 12. The positive electrode active material layer 13 is disposed between the positive electrode current collector 12 and the separator 14.

The positive electrode active material layer 13 includes a positive electrode active material. The positive electrode active material may be graphite fluoride, a metal oxide, or a metal halide. The metal oxide and the metal halide may include magnesium and at least one selected from the group consisting of scandium, titanium, vanadium, chromium, manganese, iron, cobalt, nickel, copper, and zinc. The positive electrode active material may be a sulfide, such as Mo₆S₈, or a chalcogenide compound, such as Mo₉Se₁₁.

Examples of the positive electrode active material include MgM₂O₄, MgRO₂, MgXSiO₄, and MgₓZ_{y}AO_{z}F_{w}. M includes at least one selected from the group consisting of Mn, Co, Cr, Ni, and Fe. R includes at least one selected from the group consisting of Mn, Co, Cr, Ni, and Al. X includes at least one selected from the group consisting of Mn, Co, Ni, and Fe. Z includes at least one selected from the group consisting of transition metals, Sn, Sb, and In. A includes at least one selected from the group consisting of P, Si, and S. 0<x≤2 is satisfied. 0.5≤y≤1.5 is satisfied. z is 3 or 4. 0.5≤w≤1.5 is satisfied.

The positive electrode active material layer 13 may further include at least one selected from the group consisting of conductive materials and binding agents, if necessary.

Examples of the conductive material include carbon materials, metals, inorganic compounds, and conductive polymers. Examples of the carbon materials include graphite, acetylene black, carbon black, Ketjen black, carbon whiskers, needle coke, and carbon fibers. Examples of the graphite include natural graphite and artificial graphite. Examples of the natural graphite include vein graphite and flake graphite. Examples of the metals include copper, nickel, aluminum, silver, and gold. Examples of the inorganic compounds include tungsten carbide, titanium carbide, tantalum carbide, molybdenum carbide, titanium boride, and titanium nitride. One of these materials may be used alone, or a mixture of two or more of these materials may be used.

Examples of the binding agent include fluorine-containing resins, thermoplastic resins, ethylene propylene diene monomer (EPDM) rubber, sulfonated EPDM rubber, and natural butyl rubber (NBR). Examples of the fluorine-containing resin include polytetrafluoroethylene (PTFE), polyvinylidene fluoride (PVdF), and fluoro rubber. Examples of the thermoplastic resins include polypropylene and polyethylene. These materials may be used alone, or a mixture of two or more of these materials may be used.

Examples of a solvent in which the positive electrode active material, the conductive material, and the binding agent may be dispersed include N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. A thickening agent may be added to the solvent. Examples of the thickening agent include carboxymethyl cellulose and methyl cellulose.

The positive electrode active material layer 13 can be formed, for example, by using the following method. First, a positive electrode active material, a conductive material, and a binding agent are mixed together to give a mixture of these materials. Next, an appropriate solvent is added to the mixture to give a positive electrode mixture in a paste form. Next, the positive electrode mixture is applied to a surface of the positive electrode current collector 12 and dried. In this manner, the positive electrode active material layer 13 is formed on the positive electrode current collector 12. The positive electrode active material layer 13 may be compressed to increase a density of the electrode.

The positive electrode active material layer 13 may have a thickness that is not particularly limited. The thickness may be, for example, greater than or equal to 1 μm and less than or equal to 100 μm.

A material of the positive electrode current collector 12 is, for example, an elemental metal or an alloy. More specifically, the material of the positive electrode current collector 12 may be at least one selected from the group consisting of metals and alloys. The metals are copper, chromium, nickel, titanium, platinum, gold, aluminum, tungsten, iron, and molybdenum. The alloys are alloys of any of the foregoing metals. The material of the positive electrode current collector 12 may be stainless steel.

The positive electrode current collector 12 may be in the form of a plate or a foil. The positive electrode current collector 12 may be a layered film.

The case 11 may perform a function of a positive electrode current collector. In this instance, the positive electrode current collector 12 may be omitted.

### 2-3. Negative Electrode

For example, the negative electrode 22 includes a negative electrode current collector 16 and a negative electrode active material layer 17, which includes a negative electrode active material. The negative electrode active material layer 17 is disposed between the negative electrode current collector 16 and the separator 14.

The negative electrode active material layer 17 includes a negative electrode active material into which magnesium ions can be intercalated and from which magnesium ions can be deintercalated. Examples of the negative electrode active material include carbon materials. Examples of the carbon materials include graphite, non-graphitic carbon, and graphite intercalation compounds. Examples of the non-graphitic carbon include hard carbons and coke.

The negative electrode active material layer 17 may further include at least one selected from the group consisting of conductive materials and binding agents, if necessary. For example, as a conductive material, binding agent, solvent, and thickening agent, for example, any of the conductive materials, binding agents, solvents, and thickening agents described in the “2-2. Positive Electrode” section can be appropriately used.

The negative electrode active material layer 17 may have a thickness that is not particularly limited. The thickness may be, for example, greater than or equal to 1 μm and less than or equal to 50 μm.

The negative electrode active material layer 17 may include a negative electrode active material from or in which magnesium can be deposited and dissolved. In this instance, examples of the negative electrode active material include Mg metal and Mg alloys. Examples of the Mg alloys include alloys of magnesium and a metal, and the metal is at least one selected from the group consisting of aluminum, silicon, gallium, zinc, tin, manganese, bismuth, and antimony.

As a material of the negative electrode current collector 16, for example, a material similar to the material of the positive electrode current collector 12 described in the “2-2. Positive Electrode” section can be appropriately used. The negative electrode current collector 16 may be in the form of a plate or a foil.

The seal plate 15 may perform a function of a negative electrode current collector. In this instance, the negative electrode current collector 16 may be omitted.

The negative electrode current collector 16 may be formed of a material on which magnesium can be deposited and dissolved on a surface thereof. In this instance, the negative electrode active material layer 17 may be omitted. That is, the negative electrode current collector 22 may be formed of only a negative electrode current collector 16 on which magnesium can be deposited and dissolved. In this instance, the negative electrode current collector 16 may be stainless steel, nickel, copper, or iron.

### 2-4. Separator

Examples of a material of the separator 14 include microporous membranes, woven fabrics, and nonwoven fabrics. The material of the separator 14 may be a polyolefin, such as polypropylene or polyethylene. The separator 14 has a thickness of greater than or equal to 10 μm and less than or equal to 300 μm, for example. The separator 14 may be a single-layer film formed of one material, a composite film formed of two or more materials, or a multilayer film. The separator 14 may have a porosity of greater than or equal to 30% or less than or equal to 70%, for example.

### Examples

### 3. Results of Experiments

### 3-1. Preparation of Non-Aqueous Electrolyte Solution

### Sample 1

Triglyme (G3) was used as the non-aqueous solvent. Mg[N(CF₃SO₂)₂]₂ (hereinafter referred to as Mg(TFSI)₂), which is a magnesium salt, was dissolved in the triglyme at a concentration of 0.35 mol/L. In addition, an organoaluminum ate complex salt was dissolved in the solution at a concentration of 0.05 mol/L. The organoaluminum ate complex salt was a salt that can be represented by a chemical formula of Mg[Al(O(CF₃)₃)₄]₂.7THF when the salt forms a coordinate bond with tetrahydrofuran (THF). In this manner, a non-aqueous electrolyte solution of Sample 1 was prepared.

### Sample 2

Triglyme was used as the non-aqueous solvent. Mg (TFSI)₂ was dissolved in the triglyme at a concentration of 0.40 mol/L. In this manner, a non-aqueous electrolyte solution of Sample 2 was prepared.

Sample 1 and Sample 2 both had a magnesium ion concentration of 0.40 mol/L.

### Sample 3

Triglyme was used as the non-aqueous solvent. Mg (TFSI)₂ was dissolved in the triglyme at a concentration of 0.85 mol/L. In addition, Mg[Al(O(CF₃)₃)₄]₂.7THF was dissolved in the solution at a concentration of 0.15 mol/L. In this manner, a non-aqueous electrolyte solution of Sample 3 was prepared.

### Sample 4

Triglyme was used as the non-aqueous solvent. Mg (TFSI)₂ was dissolved in the triglyme at a concentration of 1.0 mol/L. In this manner, a non-aqueous electrolyte solution of Sample 4 was prepared.

Sample 3 and Sample 4 both had a magnesium ion concentration of 1.0 mol/L.

### 3-2. Evaluation of CV Characteristics

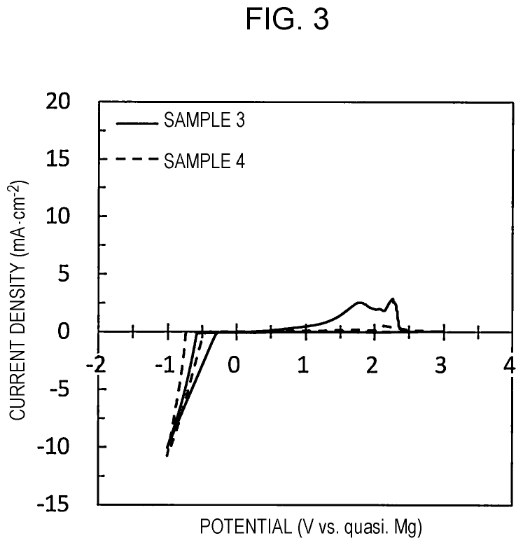

A cyclic voltammetry (CV) measurement was performed on the obtained non-aqueous electrolyte solutions. A beaker cell was used as the measuring cell, and a potentio/galvanostat (VSP-300, manufactured by Bio-Logic Science Instruments) was used as the measuring device. The working electrode used was a platinum disc electrode. The reference electrode and the counter electrode used were 5 mm×40 mm pieces of magnesium ribbon. FIG. 2 and FIG. 3 show the results of the cyclic voltammetry measurement.

From the cyclic voltammograms, an amount of electricity necessary for the deposition of magnesium metal and an amount of electricity necessary for the dissolution of magnesium metal were calculated. Coulombic efficiency was calculated by dividing the amount of electricity necessary for the dissolution of magnesium metal by the amount of electricity necessary for the deposition of magnesium metal.

FIG. 2 is a graph showing the cyclic voltammogram of Sample 1 and Sample 2. The vertical axis represents a density of the current that flowed through the working electrode, and the horizontal axis represents the potential of the working electrode versus the reference electrode. FIG. 2 shows the results obtained over a sweep range of −1 V to 3 V. A potential sweep rate was 25 mV/s. As shown in FIG. 2, a current was observed in the instance of Sample 1. It was believed that the current flow was attributable to the deposition and dissolution of magnesium metal. The coulombic efficiency of Sample 1 was 19%. On the other hand, the coulombic efficiency of Sample 2 was 10%. The coulombic efficiency of Sample 1 was significantly improved compared with the coulombic efficiency of Sample 2. The non-aqueous electrolyte solution of Sample 1 had an organoaluminum ate complex salt included therein, and it was believed that the organoaluminum ate complex salt promoted the deposition and dissolution of magnesium metal.

Based on the results described above, it is believed that the non-aqueous electrolyte solution of Sample 1 is suitable for magnesium secondary batteries.

FIG. 3 is a graph showing a cyclic voltammogram of Sample 3 and Sample 4. The vertical axis represents a density of the current that flowed through the working electrode, and the horizontal axis represents the potential of the working electrode versus the reference electrode. FIG. 3 shows the results obtained over a sweep range of −1 V to 3 V. A potential sweep rate was 25 mV/s. As shown in FIG. 3, a current was observed in the instance of Sample 3. It was believed that the current flow was attributable to the deposition and dissolution of magnesium metal. The coulombic efficiency of Sample 3 was 46%. On the other hand, the coulombic efficiency of Sample 4 was 9%. The coulombic efficiency of Sample 3 was significantly improved compared with the coulombic efficiency of Sample 4. The non-aqueous electrolyte solution of Sample 3 had an organoaluminum ate complex salt included therein, and it was believed that the organoaluminum ate complex salt promoted the deposition and dissolution of magnesium metal.

Based on the results of Sample 1 and Sample 3, it is believed that in instances where the concentration of magnesium ions in a non-aqueous electrolyte solution is increased, an organoaluminum ate complex salt further promotes the deposition and dissolution of magnesium metal.

Based on the results described above, it is believed that the non-aqueous electrolyte solution of Sample 3 is suitable for magnesium secondary batteries.

Non-aqueous electrolyte solutions of the present disclosure can be used in magnesium secondary batteries.

What is claimed is:

1. A non-aqueous electrolyte solution for a magnesium secondary battery, the non-aqueous electrolyte solution comprising:
a non-aqueous solvent,
a magnesium salt, and
an organoaluminum ate complex salt represented by formula (1) below, 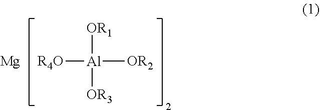
where R₁, R₂, R₃, and R₄ are each independently (i) an alkyl group or (ii) an alkyl group with a functional group.

2. The non-aqueous electrolyte solution according to claim 1, wherein the non-aqueous solvent includes an ether.

3. The non-aqueous electrolyte solution according to claim 2, wherein the non-aqueous solvent includes glyme.

4. The non-aqueous electrolyte solution according to claim 3, wherein the glyme includes at least one selected from the group consisting of 1,2-dimethoxyethane, diglyme, triglyme, and tetraglyme.

5. The non-aqueous electrolyte solution according to claim 1, wherein,
in formula (1), R₁, R₂, R₃, and R₄ are each independently represented by —CₓH_{y}F_{z},
1≤x≤4 is satisfied,
0≤y<9 is satisfied, and
1≤z≤9 is satisfied.

6. The non-aqueous electrolyte solution according to claim 1, wherein
the magnesium salt includes an anion,
the anion is at least one selected from the group consisting of Cl⁻, BF₄⁻, [N(FSO₂)₂]⁻, [N(CF₃SO₂)₂]⁻, [N(C₂F₅SO₂)₂]⁻, [N(FSO₂)(CF₃SO₂)]⁻, [CₖBₘHₙ]⁻, and [BOR₅OR₆OR₇OR₈]⁻,
k and m are each independently an integer greater than or equal to 1,
k+m=n is satisfied,
n≤60 is satisfied, and
R₅, R₆, R₇, and R₈ are each independently (i) an alkyl group or (ii) an alkyl group with a functional group.

7. The non-aqueous electrolyte solution according to claim 1, wherein
the magnesium salt includes an anion,
the anion is [CₖBₘHₙXₚ]⁻,
k, m, and p are each independently an integer greater than or equal to 1,
k+m≤n+p is satisfied,
n+p≤60 is satisfied, and
X is at least one selected from the group consisting of F, Cl, Br, and I.

8. A magnesium secondary battery comprising:
a positive electrode,
a negative electrode, and
the non-aqueous electrolyte solution according to claim 1.
